(19) United States
(12) Patent Application Publication
(10) Pub. No.: US 2008/0235246 A1
(43) Pub. Date: Sep. 25, 2008

(54) FILTER SEQUENCING BASED ON A PUBLISH-SUBSCRIBE ARCHITECTURE FOR DIGITAL SIGNAL PROCESSING

(76) Inventors: Arun Hampapur, Norwalk, CT (US); Zuoxuan Lu, Yorktown Heights, NY (US); Ying-Li Tian, Yorktown Heights, NY (US)

Correspondence Address: HOFFMAN WARNICK LLC, 75 STATE ST, 14TH FLOOR, ALBANY, NY, 12207, US

(21) Appl. No.: 11/688,287

(22) Filed: Mar. 20, 2007

(51) Int. Cl. G06F 17/00

(52) U.S. Cl. 707/100; 707/E17.001

(57) ABSTRACT

In general, the present invention allows any number of sequential filter graphs to be created based on a pub-sub architecture/model. Specifically, under the present invention, the filters (components) will publish their ideal priorities of accessing data source, an ideal input data type, and a unique alternative input data type. A mechanism such as a queue manager will receive the publication(s) and determine an appropriate order/sequence of the filters based on their ideal priorities. The queue manager will also assign an output data type to each filter (an optionally an alternative output data type) based on the ideal input types specified in the publish messages. The queue manager will then transmit messages (e.g., a subscribe message) to the filters with the determined order and assigned data types.

### FIELD OF THE INVENTION

The present invention relates to signal processing and more particularly to systems with publish-subscribe architecture and multiple filters. It solves the problem of creating any number of sequential filter graph based on publish-subscribe architecture.

### BACKGROUND OF THE INVENTION

The publish-subscribe (pub-sub) architecture is a popular model for interconnecting applications in a distributed environment. The pub-sub model allows a component (filter) to specify a set of interests, and submit the interests to the server via a publish message/communication. The server will gather the data that match the interests, and then transfer the matching data to the appropriate component (filter) via a subscribe message/communication. While being a good model for communicating the appropriate data to filter, existing pub-sub models/architectures fail to support filter ordering/sequencing. That is, there is currently approach that leverages existing pub-sub model(s) to define a specific order of filters. It is fairly common for more than one filter to be needed to adequately process data. In providing a plurality of filters, it is important to utilize the filters in a specific order/sequence for optimal results. Unfortunately, no existing approach leverages the pub-sub model to accomplish this task.

### SUMMARY OF THE INVENTION

In general, the present invention allows any number of sequential filter graphs to be created based on a pub-sub architecture/model. Specifically, under the present invention, the filters (components) will publish their ideal priorities of accessing data source, an ideal input data type, and a unique alternative input data type. A mechanism such as a queue manager will receive the publication(s) and determine an appropriate order/sequence of the filters based on their ideal priorities. The queue manager will also assign an output data type to each filter (an optionally an alternative output data type) based on the ideal input types specified in the publish messages. The queue manager will then transmit messages (e.g., a subscribe message) to the filters with the determined order and assigned data types.

A first aspect of the present invention provides a method for sequencing filters, comprising: receiving publish messages from a plurality of filters, the publish messages containing priority values and ideal data types for the plurality of filters; and determining an order of the plurality of filters with respect to one another for processing data based on the priority values.

A second aspect of the present invention provides a system for sequencing filters, comprising: a system for receiving publish messages from a plurality of filters, the publish messages containing priority values and ideal data types for the plurality of filters; a system for determining an order of the plurality of filters based on the priority values; and a system for assigning data types to the plurality of filters based on the ideal data types received in the publish messages.

A third aspect of the present invention provides a program product stored on a computer readable medium for sequencing filters, the computer readable medium comprising program code for causing a computer system to: receive publish messages from a plurality of filters, the publish messages containing priority values and ideal data types for the plurality of filters; determine an order of the plurality of filters based on the priority values; and assign data types to the plurality of filters based on the ideal data types received in the publish messages.

A fourth aspect of the present invention provides a method for deploying a system for sequencing filters, the computer readable medium comprising: providing a computer infrastructure being configured to: receive publish messages from a plurality of filters, the publish messages containing priority values and ideal data types for the plurality of filters; determine an order of the plurality of filters based on the priority values; and assign data types to the plurality of filters based on the ideal data types received in the publish messages.

A fifth aspect of the present invention provides computer software embodied in a propagated signal medium for sequencing filters, the computer software comprising instructions for causing a computer system to: receive publish messages from a plurality of filters, the publish messages containing priority values and ideal data types for the plurality of filters; determine an order of the plurality of filters based on the priority values; and assign data types to the plurality of filters based on the ideal data types received in the publish messages.

A sixth aspect of the present invention provides a data processing system for sequencing filters, comprising: a memory medium having instructions; a bus coupled to the memory medium; and a processor coupled to the bus that when executing the instructions causes the data processing system to: receive publish messages from a plurality of filters, the publish messages containing priority values and ideal data types for the plurality of filters; determine an order of the plurality of filters based on the priority values; and assign data types to the plurality of filters based on the ideal data types received in the publish messages.

A seventh aspect of the present invention provides a computer-implemented business method for sequencing filters, comprising: receiving publish messages from a plurality of filters, the publish messages containing priority values and ideal data types for the plurality of filters; and determining an order of the plurality of filters with respect to one another for processing data based on the priority values.

Each of these aspects can also include one or more of the following aspects: Subscribe messages are transmitted to the plurality of filters after the order has been determined and the data types have been assigned. The subscribe messages specify output data types for the plurality of filters, and an input data type for at least one of the plurality of filters. The order and data types are determined/assigned by a queue manager. The publish messages and the subscribe messages are generated pursuant to a publish-subscribe model. A separate publish message is received from at least two of the plurality of filters, each of the separate publish messages comprising a priority value and an ideal input type for a corresponding filter. Each of the separate publish messages further comprise an alternative input type for the corresponding filter.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative publish-subscribe (pub-sub) architecture according to an aspect of the present invention.

FIG. 2 shows an illustrative pub-sub architecture being used to order/sequence filters (components) according to an aspect of the present invention.

FIG. 3 shows the virtual ordering/sequencing filters based on the priority of the filters shown in FIG. 2 according to an aspect of the present invention.

FIG. 4 shows a more detailed computerized implementation according to an aspect of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description

II. Computerized Implementation

### I. General Description

As indicated above, the present invention allows any number of sequential filter graphs to be created based on a pub-sub architecture/model. Specifically, under the present invention, the filters (components) will publish their ideal priorities of accessing data source, an ideal input data type, and a unique alternative input data type. A mechanism such as a queue manager will receive the publication(s) and determine an appropriate order/sequence of the filters based on their ideal priorities. The queue manager will also assign an output data type to each filter (an optionally an alternative output data type) based on the ideal input types specified in the publish messages. The queue manager will then transmit messages (e.g., a subscribe message) to the filters with the determined order and assigned data types.

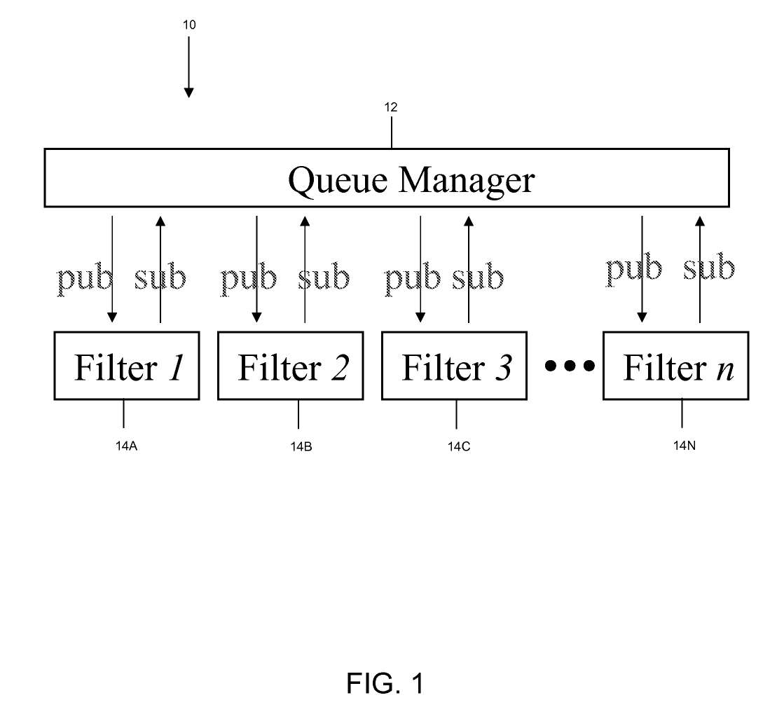

In generals, the present invention can generate flexible orders/sequences for multiple filters using a pub-sub architecture in a distributed environment. All or some of the filters can be placed in the order based on the priority information, which is published by each filter. Referring briefly to FIG. 1, an illustrative pub-sub model 10 is shown. As depicted, queue manager 12 is in communication with filters 14A-N. Each filter 14A-N sends a “publish” message to queue manager, which in turn sends a “subscribe” message back. Further, as shown, each filter 14A-N is in individual communication with queue manager 12, which means that each filter 14A-N will send and receive their own messages (although this need not be the case). As will be further described below, the present invention will leverage pub-sub model 10 to determine an order in which filters 12A-N will be used, as well as to assign data types thereto.

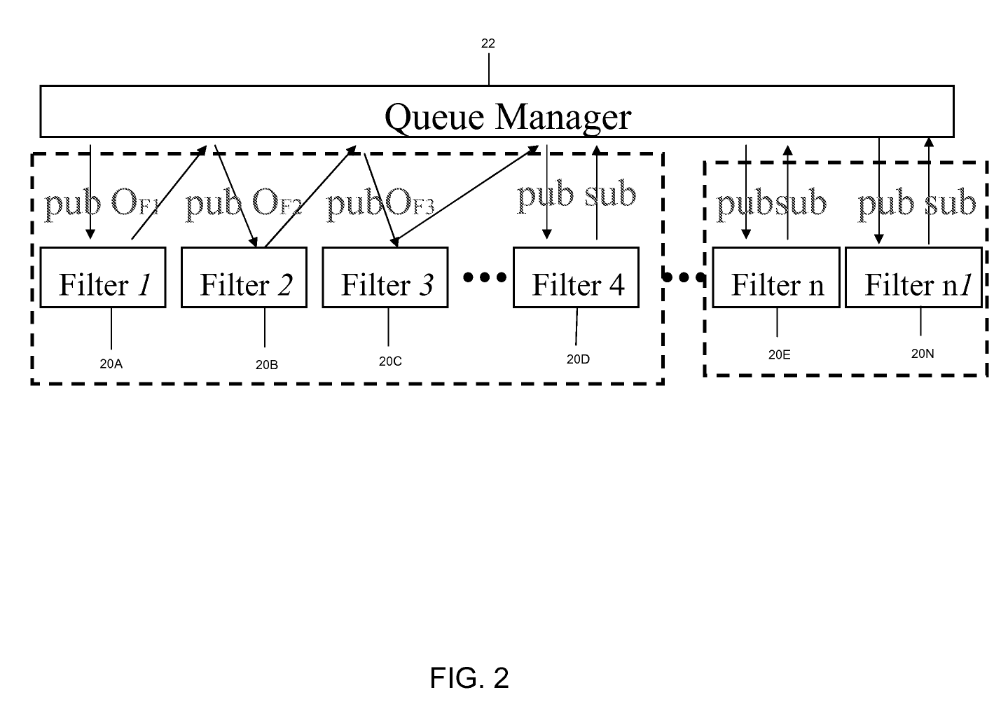

Referring now to FIG. 2, an illustrative set of filters 20A-N in communication with queue manager 22 is shown. As indicated above, filters 20A-N will transmit a publish message to queue manager 22. Each publish message typically includes an ideal priority (value) for the respective filter, an ideal data type (e.g., input and/or output data type), as well as an alternate data type (e.g., alternate input and/or output data type). Upon receipt, queue manager 22 will determine an order/sequence of filters based on the submitted priority values, and assign a data type (e.g., output data type) to each filter 20A-N. Queue manager 22 will then transmit a subscribe message to filters 20A-N (e.g., an individual message to each filter 20A-N), informing filters 20A-N of their position in the order and their assigned data type (e.g., typically, their output data type).

For example, in video processing (as shown in FIG. 2), assume that filters 20A-N have the following priorities and ideal data types:

Filter 20A outputs MediaImage type data and has priority P1.

Filter 20B is a video pre-processing filter that inputs and outputs MediaImage type data and has priority P2;

Filter 20C is a video stabilization filter that inputs and outputs MediaImage type data and has priority P3; and

Filter 20D is a background subtraction filter that inputs MediaImage, outputs MaskImage type data, and has priority P4.

In order to get good results from the background subtraction filter 20D the following filter graph (order of filters) should be created:

Filter 20A-Filter 20B-Filter 20C-Filter 20D

Based on this desired priority, and at filter graph initializing stage:

(1) Filter 20A publishes a message, declaring it is a capture filter and its ideal input data type is MediaImage. The priority of the filter P1 is set as the highest priority (e.g. p1=1, smaller value indicate higher priority.)

(2) Filter 20B published a message, declaring its priority P2 (p2=20), ideal input data type MediaImage, and its alternative input type Filter2Type.

(3) Filter 20C published a message, declaring its priority p3 (p3=40), ideal input data type MediaImage, and its alternative input type Filter3Type;

(4) Queue manager 22 sorts filter 20A-C order by their priority, and publishes a message for each filter 20A-C (or 20A-D);

(5) Message for filter 20A tells filter 20A to output data type Filter2Type;

(6) Message for filter 20B tells filter 20B to take Filt2erType as input, and output data type Filter3Type;

(7) Message for filter 20C tells filter 20C to take Filter3Type as input, and output data type MediaImage; and

(8) Filter 20D inputs MediaImage data type, and outputs data type MaskImage data type.

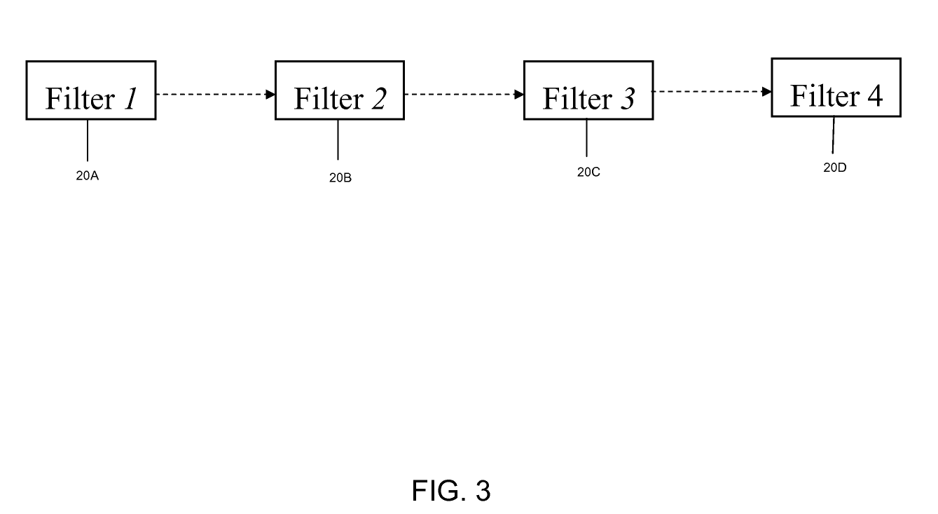

The order of filters 20A-D is shown in FIG. 3 for illustrative purposes. To this extent, the quantity and order/sequence of filters 20A-D can be varied within the scope of the present invention. In any event, as can be seen, the present invention leverages a pub-sub model to establish an order/sequence of filters, and to assign data types to the filters.

### II. Computerized Implementation

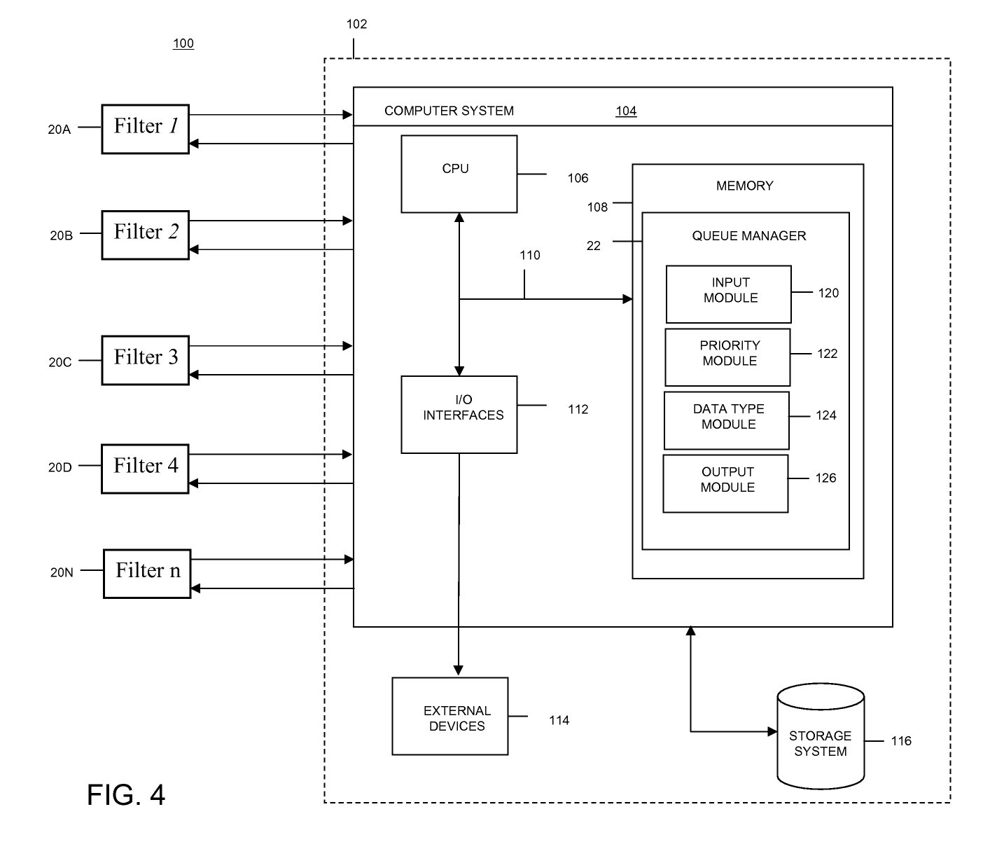

Referring now to FIG. 4, a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, such as queue manager 22, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any system for exchanging information with one or more external device 114. Still further, it is understood that one or more additional components (e.g., system software, math co-processing unit, etc.) not shown in FIG. 4 can be included in computer system 104. However, if computer system 104 comprises a handheld device or the like, it is understood that one or more external devices 114 (e.g., a display) and/or storage system 116 could be contained within computer system 104, not externally as shown.

Storage system 116 can be any type of system (e.g., a database) capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is queue manager 22, which includes input module 120, priority module 122, data type module 124, and output module 126. It should be understood that this configuration of modules is intended to be illustrative only, and that identical or similar functionality could be provided with a different configuration of modules. In addition, filters 20A-D could be implemented by one or more computer systems that communicate with computer system 104 in a distributed environment. Alternatively, filters 20A-N could be implemented by computer system 104. Regardless, as indicated above, the present invention utilizes a pub-sub model to determine an order of filters 20A-N with respect to one another, and to assign a data type (e.g., an output data type) to filters 20A-N.

To this extent, input module 120 will receive “publish” messages from filters 20A-N. These publish messages will typically include an intended or ideal priority value, an ideal input data type, and a unique alternative input data type. In a typical embodiment, input module 120 will receive a separate publish message from each filter 20A-N, although this need not be the case. Regardless, priority module 122 will analyze the priority values received in the publish messages, and determine an order of the filters 20A-N with respect to one another based on the priority values. In addition, data type module 124 will assign at least one data type (e.g., input and/or output data type depending on the particular filter and its order with respect to the other filters). Once the data type(s) have been assigned, output module 126 will transmit a “subscribe” message to each filter 20A-N that informs each filter 20A-N of its respective position in the order, as well as the data type(s) that it should receive as input and/or output. To this extent, filters 20A-N and queue manager 22 should be understood to include logic capable of implementing a pub-sub model in accordance with the present invention, as generally shown in FIG. 1.

While shown and described herein as a method and framework for sequencing/ordering filters based on a pub-sub model, it is understood that the invention further provides various alternative embodiments. For example, in one embodiment, the invention provides a computer-readable/useable medium that includes computer program code to enable a computer infrastructure to sequence/order filters based on a pub-sub model. To this extent, the computer-readable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 4) and/or storage system 116 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscriber, advertising, and/or fee basis. That is, a service provider, such as a Solution Integrator, could offer to sequence/order filters based on a pub-sub model. In this case, the service provider can create, maintain, support, etc., a computer infrastructure, such as computer infrastructure 102 (FIG. 4) that performs the process of the invention for one or more customers. In return, the service provider can receive payment from the customer(s) under a subscribe and/or fee agreement and/or the service provider can receive payment from the sale of advertising content to one or more third parties.

In still another embodiment, the invention provides a computer-implemented method for sequencing/ordering filters based on a pub-sub model. In this case, a computer infrastructure, such as computer infrastructure 102 (FIG. 4), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 4), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for sequencing filters, comprising:
receiving publish messages from a plurality of filters, the publish messages containing priority values and ideal data types for the plurality of filters; and
determining an order of the plurality of filters with respect to one another for processing data based on the priority values.

2. The method of claim 1, further comprising assigning data types to the plurality of filters based on the ideal data types received in the publish messages.

3. The method of claim 2, further comprising transmitting subscribe messages to the plurality of filters after the order has been determined and the data types have been assigned.

4. The method of claim 3, the subscribe messages specifying output data types for the plurality of filters, and an input data type for at least one of the plurality of filters.

5. The method of claim 2, the determining and assigning being performed by a queue manager.

6. The method of claim 2, the publish messages and the subscribe messages being generated pursuant to a publish-subscribe model.

7. The method of claim 2, the receiving comprising receiving a separate publish message from at least two of the plurality of filters, each of the separate publish messages comprising a priority value and an ideal input type for a corresponding filter.

8. The method of claim 7, each of the separate publish messages further comprising an alternative input type for the corresponding filter.

9. A system for sequencing filters, comprising:
a system for receiving publish messages from a plurality of filters, the publish messages containing priority values and ideal data types for the plurality of filters;
a system for determining an order of the plurality of filters based on the priority values; and
a system for assigning data types to the plurality of filters based on the ideal data types received in the publish messages.

10. The system of claim 9, further comprising a system for transmitting subscribe messages to the plurality of filters after the order has been determined and the data types have been assigned.

11. The system of claim 10, the subscribe messages specifying output data types for the plurality of filters, and an input data type for at least one of the plurality of filters.

12. The system of claim 9, system comprising a queue manager.

13. The system of claim 9, the receiving comprising receiving a separate publish message from at least two of the plurality of filters, each of the separate publish messages comprising a priority value and an ideal input type for a corresponding filter.

14. The system of claim 13, each of the separate publish messages further comprising an alternative input type for the corresponding filter.

15. A program product stored on a computer readable medium for sequencing filters, the computer readable medium comprising program code for causing a computer system to:
receive publish messages from a plurality of filters, the publish messages containing priority values and ideal data types for the plurality of filters;
determine an order of the plurality of filters based on the priority values; and
assign data types to the plurality of filters based on the ideal data types received in the publish messages.

16. The program product of claim 15, the computer readable medium further comprising program code for causing the computer system to transmit subscribe messages to the plurality of filters after the order has been determined and the data types have been assigned.

17. The program product of claim 16, the subscribe messages specifying output data types for the plurality of filters, and an input data type for at least one of the plurality of filters.

18. The program product of claim 15, program product being implemented in conjunction with a queue manager.

19. The program product of claim 15, the computer system being caused to receive a separate publish message from at least two of the plurality of filters, each of the separate publish messages comprising a priority value and an ideal input type for a corresponding filter.

20. The program product of claim 19, each of the separate publish messages further comprising an alternative input type for the corresponding filter.

21. A method for deploying a system for sequencing filters, the computer readable medium comprising:
providing a computer infrastructure being configured to:
receive publish messages from a plurality of filters, the publish messages containing priority values and ideal data types for the plurality of filters;
determine an order of the plurality of filters based on the priority values; and
assign data types to the plurality of filters based on the ideal data types received in the publish messages.
